(19) United States
(12) Patent Application Publication
(10) Pub. No.: US 2007/0095370 A1
(43) Pub. Date: May 3, 2007

(54) Mobile high-temperature washing plant

(76) Inventor: Vladimir Kratser, Salt Lake City, UT (US)

Correspondence Address: DAVID R. MCKINNEY, P.C., 8 EAST BROADWAY, SUITE 500, SALT LAKE CITY, UT, 84111, US

(21) Appl. No.: 11/591,815

(22) Filed: Nov. 2, 2006

Related U.S. Application Data
(60) Provisional application No. 60/733,057, filed on Nov. 3, 2005.

(51) Int. Cl. B08B 3/00; B08B 3/12; B60H 3/00

(52) U.S. Cl. 134/105; 134/123; 134/184; 134/172; 134/198; 165/43

(57) ABSTRACT

A mobile high-temperature washing plant, disposed upon a motor vehicle having an engine, includes a cleaning water storage vessel, a pump configured to pump the cleaning water from the cleaning water storage vessel for cleaning use, and a vacuum system for withdrawing and disposing of used cleaning water. An engine coolant heat exchange system initially heats the cleaning water associated with the water storage vessel to a first elevated temperature, and an exhaust heat exchanger heats the cleaning water to a second higher elevated temperature for cleaning.

### CROSS-REFERENCE AND PRIORITY CLAIM

This application claims priority from U.S. Provisional patent application Ser. No. 60/733,057, filed Nov. 3, 2005.

### BACKGROUND

1. Field of the Invention

The present invention relates generally to mobile systems for heating water for carpet cleaning, washing, and the like.

2. Related Art

The professional carpet cleaning industry has developed because of the difficulty of keeping carpets clean. Carpets are constantly exposed to dirt, grease, sand, dust, plant matter, mud, animal hair, animal excrement, spilled food, and other contaminants. The problem of cleaning carpets is further aggravated by the length of carpet fibers. Dirt, soil, and particulate matter are more likely to adhere to carpets having longer fibers or fibers comprising bundles or strands of many fibers.

Additionally, permanent (e.g. wall-to-wall) carpet is not intended to be removed for cleaning, and, as a practical matter cannot be, and thus requires on-site cleaning. Consequently, a mobile carpet cleaning industry has developed. There are a variety of mobile carpet cleaning systems that are commercially available and in widespread use. Unfortunately, many of these have significant shortfalls.

Many mobile carpet cleaning systems employ a hot water extraction method. The term “hot water” can include liquid water, steam and water combined, or superheated steam, though steam is rarely used because it can permanently damage or distort carpet fibers (particularly synthetic fibers), and since most mobile water heating plants cannot provide sufficient energy to produce steam. Under the hot water extraction methods in common use, water is typically heated, pressurized, and mixed with chemical cleaning agents, and the mixture is applied to carpet at an elevated pressure in order to dissolve dirt, soil and particulates. A vacuum system then draws the cleaning water containing the dissolved dirt out of the carpet, and delivers it to a holding tank.

It is known that the temperature of cleaning fluids greatly influences their effectiveness. The higher the temperature of a cleaning fluid, the more effective will be the cleaning process. However, temperatures in excess of about 240° F. can permanently yield synthetic fibers, causing fiber memory loss and ruining the pile texture of carpet. Consequently, for the most effective carpet cleaning, it is desirable that the water temperature be as high as possible, so long as it is not so high as to damage or distort the carpet fibers. Unfortunately, most mobile carpet cleaning systems are not capable of controllably heating water to such temperatures. When water is substantially cooler, cleaning is not as effective. Consequently, machine operators often compensate by increasing the pressure, chemical content, or quantity of the cleaning fluid, or some combination thereof.

Unfortunately, these approaches have some negative effects. Excess water in carpets can lead to mildew and delamination of the carpet from its backing. The use of chemical cleaning agents can discolor carpets, remove stain-resisting treatments, and harm glue or carpet backing material. Also, cleaning chemicals can leave a residue that causes dirt and soil to adhere more readily, causing the carpet to become dirtier faster.

It has been found that if the water temperature is high enough, carpets can be effectively cleaned with water alone, without the use of chemical additives, high fluid pressure, or large quantities of water. This can improve the application and drying process, resulting in less soaking, shorter water residence time, better extraction of water from the cleaned carpet, shorter drying time, and less risk of delamination, mold growth, loss of strength, and chemical residue. For these results of water-only cleaning to be consistent, cleaning fluid temperatures must not only be high, but consistent. The effectiveness of any hot-water extraction method depends greatly on the fluid temperature. Consequently, an inconsistent fluid temperature can result in uneven cleaning.

Mobile hot-water carpet cleaning systems that attempt to reach these higher temperatures have been developed. Unfortunately, known systems either are not capable of attaining the higher temperatures, or cannot do so consistently or controllably. Many prior vehicle-mounted carpet cleaning systems use heated coolant from the vehicle engine to heat the cleaning water. However, engine coolant in gasoline engines normally does not exceed 220° F., and diesel engines run at about 180° F. It is a basic principle of thermodynamics that heat transfer from one body to another cannot cause the second body to attain a temperature higher than that of the first body. Consequently, engine coolant can never heat cleaning fluid to the higher temperatures that are desirable for water-only cleaning.

In light of this problem, mobile heating systems have been designed and built that draw heat from the vehicle exhaust. Vehicle exhaust, whether from a gasoline or diesel engine, normally exceeds 400° F. and can be as high as 1400° F., and therefore has the potential to heat water to temperatures well in excess of 200° F. Some such systems have attempted to heat water through direct contact with the exhaust system of the vehicle, by using a heat exchanger that has a flow of engine exhaust therethrough. Unfortunately, these systems can be very difficult to control, and do not provide consistent high temperatures without sometimes exceeding the maximum desired cleaning temperature. Exhaust gases from an internal combustion engine can vary significantly in temperature due to changes in the combustion rate and temperature of the engine. In addition, cleaning fluid moving comparatively slowly through a heat exchanger during a time of less use of such fluid by an operator will absorb more heat and exit the exchanger at a comparatively higher temperature. If an operator momentarily stops cleaning to move furniture, reposition equipment, or make a dry pass to vacuum up excess cleaning fluid, the flow rate of cleaning fluid through a washing plant can slow or stop. During that time, the water temperature can spike, creating temperatures and pressures that can harm carpet, destroy equipment, or cause personal injury. Then, when water flow is resumed, the temperature can plummet to levels that do not provide adequate cleaning.

Many systems that use exhaust gases for heating cleaning fluid are configured to deal with temperature spikes by jettisoning heated cleaning fluid when it becomes too hot. Unfortunately, the jettisoned cleaning fluid must be replenished before cleaning can resume, and jettisoned cleaning fluid wastes both heat and fluid. Moreover, anything vented to a holding tank reduces the useful capacity of that tank, and must be dumped along with the dirty, used cleaning fluid. Such approaches are inconvenient and are also potentially harmful to the environment.

Other systems that use exhaust gases for heating cleaning fluid are configured to deal with temperature spikes by shutting down the exhaust heat transfer when water flow slows or stops. However, devices that shut down the system are also inconvenient, and can present safety problems. A failure in a temperature regulating mechanism can allow the fluid temperature to continue rising to dangerous levels. Meanwhile, electrical and electronic control elements, such as sensors, solenoids, and valves, used to detect excessive temperatures and bleed off cleaning fluid or shut down the system are prone to failure. Control orifices can be very small and are subject to clogging from calcium, lime, and magnesium deposits from the cleaning fluid. The high temperatures involved accelerate the buildup of these deposits and can damage the wire coils and insulation, causing failure in items such as solenoids. Valve failures can also cause catastrophic failure of the entire system.

To help mitigate some of the problems associated with direct exhaust-to-cleaning-fluid heat transfer systems, systems have been designed that use an intermediate heat transfer loop. Such a system is disclosed in U.S. Pat. No. 6,675,437, the disclosure of which is incorporated herein by reference in its entirety. Such systems include a second heat exchanger, with an intermediate heat transfer fluid in a closed loop between the second heat exchanger and the exhaust heat exchanger. The cleaning fluid flows through the second heat exchanger, drawing heat from the intermediate heat transfer fluid, and the temperature of the heat transfer fluid is controlled through selective diversion of exhaust gasses into or away from the exhaust heat exchanger. While such systems do provide an improvement in cleaning fluid temperature control, the use of an intermediate heat transfer system introduces significant additional complexity and inefficiency to the system. The additional heat transfer step necessarily wastes heat, and requires significant complicated apparatus for pumping, storing, and heating the intermediate heat transfer fluid.

### SUMMARY

It has been recognized that it would be advantageous to develop a mobile washing plant capable of safely and efficiently capturing heat from both the radiator coolant and engine exhaust gases of a vehicle.

It has also been recognized that it would be advantageous to have such a washing plant that can safely provide consistently high cleaning fluid temperatures without overheating.

It has also been recognized that it would be advantageous to have such a washing plant that is rugged and reliable and has a long useful life and is not overly complex.

In accordance with one aspect thereof, the present invention provides a mobile high-temperature washing plant disposed upon a motor vehicle having an engine. The mobile washing plant includes a cleaning water storage vessel, a pump configured to pump the cleaning water from the cleaning water storage vessel for cleaning use, and a vacuum system for withdrawing and disposing of used cleaning water. An engine coolant heat exchange system initially heats the cleaning water associated with the water storage vessel to a first elevated temperature, and an exhaust heat exchanger heats the cleaning water to a second higher elevated temperature for cleaning.

In accordance with another aspect thereof, the invention provides a vehicle, comprising a frame, an engine affixed to the frame as a prime mover of the vehicle, and a transmission system connected to the engine for transmitting mechanical energy from the engine to the drive train of the vehicle. The engine is configured to be the sole source of energy to pump and heat a cleaning fluid. Also disposed on the vehicle are a storage tank that stores the cleaning fluid, and a pump coupled to the storage tank and configured to pump the cleaning fluid. A power takeoff is connected to the transmission system for driving the liquid pump, and an exhaust line is connected to the engine for conducting combustion exhaust from the engine. An exhaust heat exchanger is connected to the engine to transfer heat from the combustion exhaust directly to the cleaning fluid, so as to heat the cleaning fluid to a temperature suitable for suspending particulate matter from a carpet.

In accordance with another aspect thereof, the invention provides a transportable cleaning apparatus for heating and pressurizing a cleaning fluid for cleaning purposes. The apparatus includes an engine configured to provide a motive force for the apparatus and to pump and heat the cleaning fluid to a suitable temperature for a desired cleaning purpose, and a transmission system coupled to the engine. The apparatus includes a storage tank that stores the cleaning fluid. A fluid pump is in fluid communication with the cleaning fluid in the storage tank and is configured to pump the cleaning fluid through a cleaning fluid conduit. A first heat exchanger is disposed along the cleaning fluid conduit and coupled to the engine, and configured to receive a thermal transfer fluid from the engine and to heat the cleaning fluid as the cleaning fluid conduit passes through the first heat exchanger in a first heating stage. A second exhaust heat exchanger is disposed along the cleaning fluid conduit and coupled to an exhaust conduit of the engine, and configured to receive hot exhaust gasses from the engine and to heat the cleaning fluid as the cleaning fluid conduit passes through the exhaust heat exchanger in a second heating stage.

In accordance with yet another aspect thereof, the invention provides a four-stage exhaust heat exchanger. The four-stage exhaust heat exchanger includes an exhaust pipe configured to direct hot exhaust gasses from an engine, and a plurality of groups of exhaust conduits arranged in parallel, in fluid communication with the exhaust pipe. An elongate fluid jacket is disposed around each of the plurality of groups of exhaust conduits, and is configured to allow cleaning fluid to circulate around the exhaust conduits, the exhaust conduits separating the cleaning fluid from the exhaust gasses. Transfer conduits are placed to interconnect the fluid jackets in series, such that cleaning fluid introduced into a first of the fluid jackets will flow sequentially through each fluid jacket to an outlet disposed in a last of the fluid jackets, such that the cleaning fluid is heated by thermal transfer from the hot exhaust gasses in successive stages.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a schematic diagram of one embodiment of a mobile high-temperature washing plant in accordance with the present invention;

FIG. 2 is a schematic diagram showing the water heating system of the mobile high-temperature washing plant of FIG. 1;

FIG. 3 is a top view of a mobile high-temperature washing plant mounted on a small truck;

FIG. 4 is a close-up side view of one embodiment of a multi-shell exhaust heat exchanger configured for use with the mobile high-temperature washing plant of FIG. 1;

FIG. 5 is a cross-sectional view of the multi-shell exhaust heat exchanger of FIG. 3, taken along line 5-5 in FIG. 3, showing the four heat exchange stages;

FIG. 6 is a cross-sectional view of the multi-shell exhaust heat exchanger of FIG. 3, taken along line 6-6 in FIG. 3, showing the water inlet and outlet positions, and the position of the temperature sensor between stages 2 and 3;

FIG. 7 is a schematic diagram of another embodiment of a mobile high-temperature washing plant in accordance with the present invention, having the exhaust heat exchanger outside the cargo bay;

FIG. 8 is a plan view of an exhaust heat exchanger having four heat exchange stages arranged side-by-side; and

FIG. 9 is a cross-sectional view of the exhaust heat exchanger of FIG. 8.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

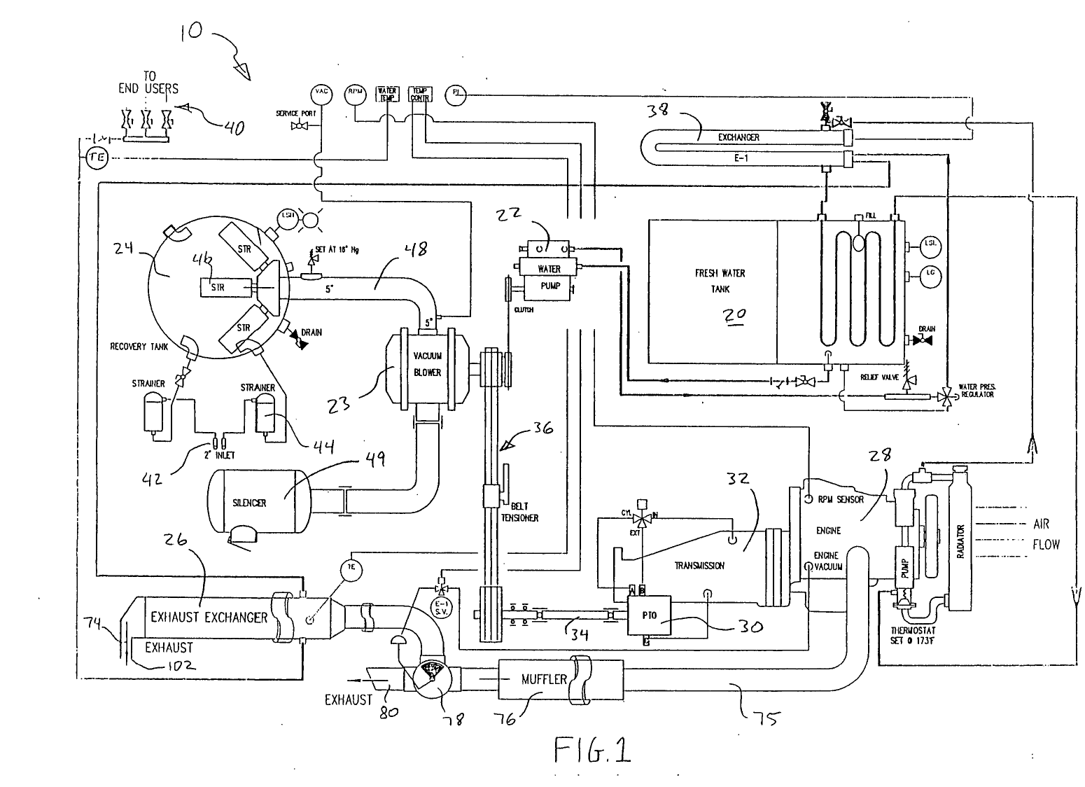

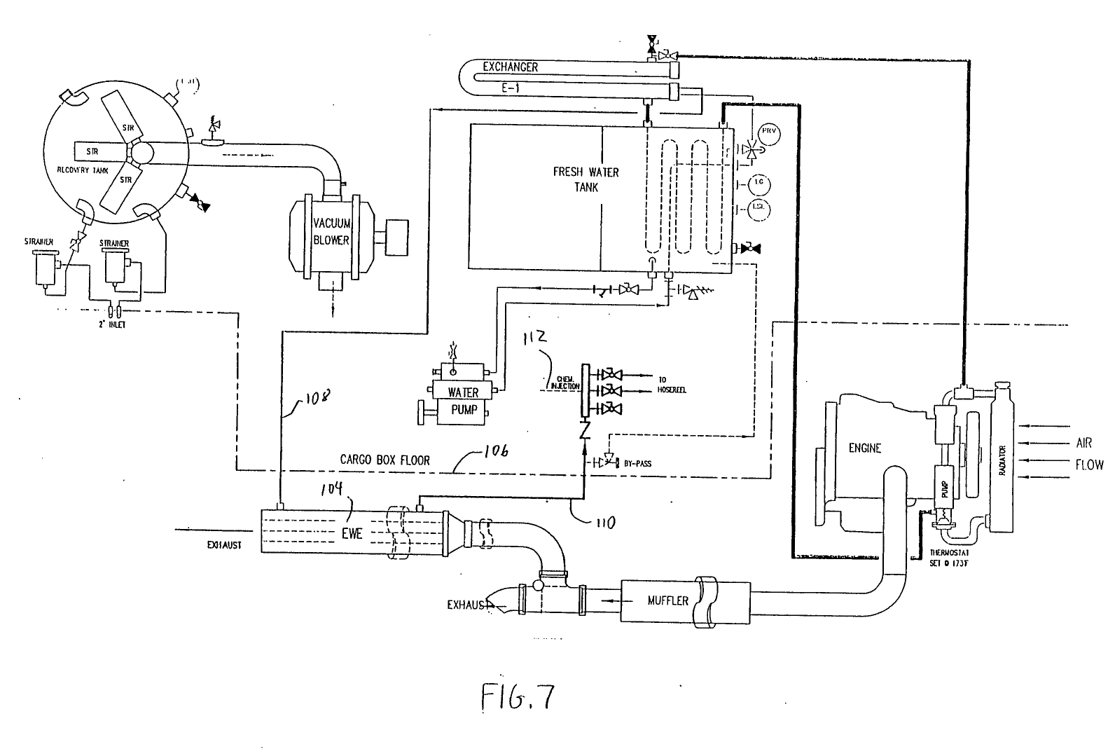

Provided in FIG. 1 is a schematic diagram of one embodiment of a mobile high temperature washing system 10 in accordance with the present invention. Although the invention is described with respect to cleaning carpets, it is also suitable for cleaning upholstery on furniture, such as chairs and sofas, cleaning forced-air registers, walls, outdoor surfaces such as driveways, walk ways, building exteriors such as stucco, brick, and vinyl siding, among others. This cleaning system can also be used for performing hazardous material cleanup. Additionally, while this system is configured to provide high temperature cleaning water suitable for water-only cleaning of carpets and the like, this system is not limited to water-only cleaning. The system can be used with cleaning agents or chemicals, as indicated in FIG. 7, wherein a chemical injection conduit 112 is provided at the cleaning hose connection points. As used herein, the terms “cleaning water” and “cleaning fluid” are interchangeable, and are both intended to include water alone, and water mixed with chemicals or other additives.

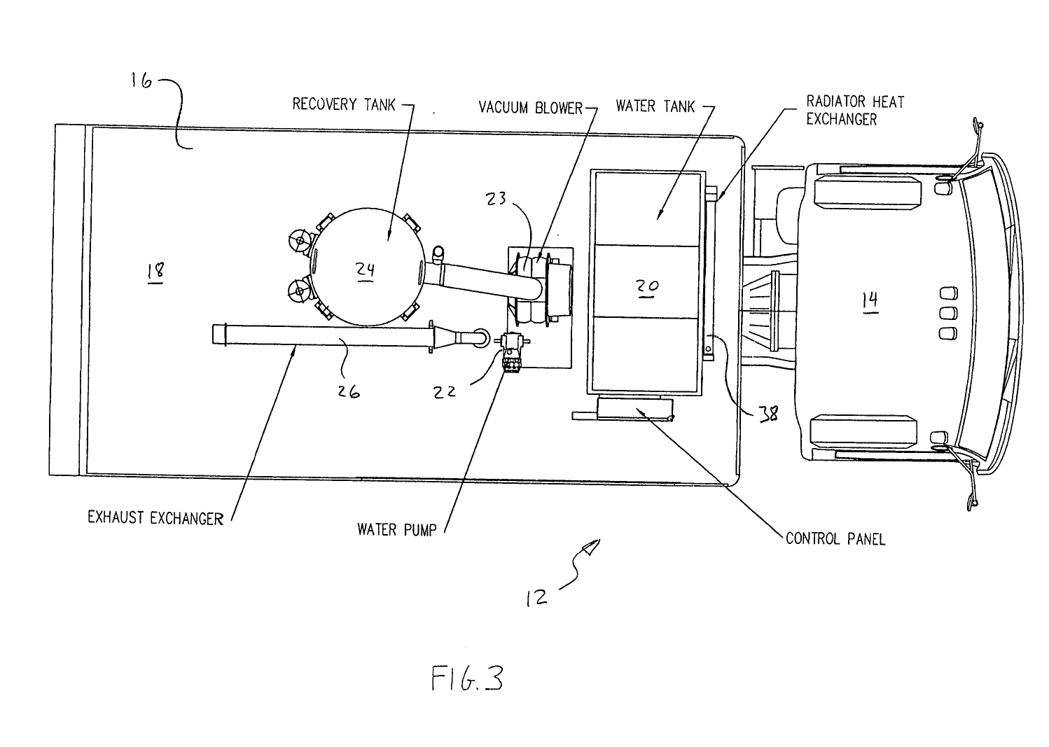

The high-temperature washing system 10 is configured to be mounted in or on a vehicle, such as a truck 12 shown in FIG. 3. The truck includes a cab portion 14, and a cargo bay portion 16 with a floor 18. Mounted in the cargo bay are a cleaning water storage tank 20, a pump 22, a blower 23, a recovery tank or dump tank 24, and an exhaust heat exchanger 26. The cleaning water storage tank is part of a fluid storage and preheat system, the pump provides a fluid drive system, and the exhaust heat exchanger provides a second fluid heating system. The recovery tank provides a waste storage system for containing used, dirty cleaning fluid. The mobile cleaning system will also include hoses, cleaning wands, and other apparatus (not shown) that are used to apply and extract the heated cleaning water and are well known by those skilled in the art to be associated with mobile carpet cleaning systems.

Referring to FIG. 1, the truck (12 in FIG. 3) includes an engine 28 that is the prime mover of the vehicle, and also is the sole source of heat for the water heating system. A power take-off (PTO) 30 is attached to the truck transmission 32, and drives a drive shaft 34, which provides mechanical power through a belt system 36 to the vacuum blower 23 and water pump 22. While a belt and pulley system is depicted, it will be apparent that other mechanical systems and devices can be used, such as gears, to transmit power from the PTO to the blower and water pump. A clutch (not shown) can also be provided as part of the PTO or connected to it to link the PTO to the drive shaft when activated by a user. Provision of a clutch downstream (with respect to power flow) of the transmission system can help reduce additional wear on the transmission from repeated engagement and disengagement with the PTO. Thus, the PTO can remain continually meshed with the transmission system, thus avoiding problems that might result from frequent engagement and disengagement of gears or other mechanical power transfer devices. The clutch can be one of many types known in the art, such as mechanical, hydraulic, and hydraulically actuated clutches.

The water pump 22 first pumps water from the cleaning water storage tank 20 through a first engine coolant heat exchanger (E-1) 38, and thence through the exhaust heat exchanger 26, and to the end user connections 40. After the cleaning water is used, it is drawn by vacuum pressure (supplied by the blower 23) into the recovery tank 24. The blower 23 creates a pressure differential to induce, or draw, air into an air channel of the cleaning tool (not shown) and through a return line (not shown) that is connected through inlets 42, and passing into the dump tank. Strainers 44 are provided to help remove large particulate matter from the returned cleaning water. The dump tank 24 separates the extracted cleaning fluid from air and vapor. Additional strainers or filters 46 are connected to the main blower pipe 48, and further remove water and vapor from the vacuum air that is drawn through the dump tank and to the blower. Air passing out of the dump tank thus contains only a comparatively low concentration of vaporized cleaning fluid. The blower expels pumped air through a muffler or silencer 49. The muffler dampens noise created by the high volumetric flow rate of the blower.

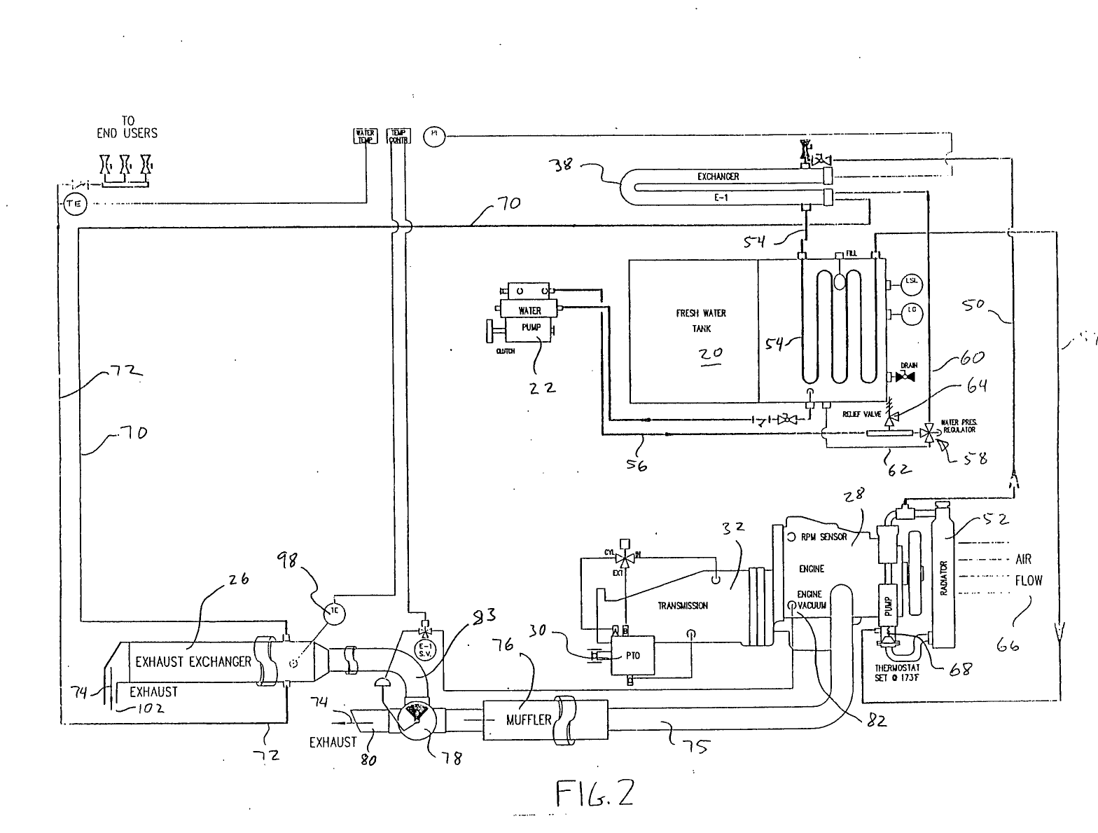

Cleaning fluid is stored in the storage tank 20, and is heated in several stages for cleaning purposes. FIG. 2 provides a simplified schematic diagram of just the water heating elements of the system. In the first stage of heating, an engine coolant line 50 transmits heated engine coolant from the engine 28 to the first heat exchanger 38. After flowing through the first heat exchanger, a coolant return line 54 passes through the cleaning water storage tank in a serpentine configuration, and then returns to the engine. The cleaning water is first heated through conduction from the coolant return line within the storage tank. This configuration allows initial heating of the cleaning fluid through conduction within the storage tank while the vehicle is traveling to a job site, for example. This can be advantageous by providing some initial heating when the vehicle is traveling to its first job on a particular day, and the water in the tank has cooled overnight. The resulting temperature rise provides a first or preheating stage for the cleaning fluid.

Once the heating and washing system 10 is engaged, the water pump 22 draws cleaning water from the storage tank 20 and pumps it through line 56 toward the first heat exchanger 38. After passing through the pump, the cleaning fluid reaches a regulator 58, which acts as a three-way valve, having three outlets. If the fluid applicator system is using (distributing, passing) fluid, at least a portion of the cleaning fluid flowing through the regulator will exit into supply line 60 leading to the first heat exchanger 38. Any cleaning fluid not required by the fluid applicator system exits into a return line 62 and reenters the storage tank directly.

A malfunction of any flow path beyond the regulator 58 may be reflected therein. For example, an obstruction in the regulator, valves, or the associated lines carrying cleaning fluid, will cause the regulator to relieve pressure caused the obstructed flow, directing it into the ambient through a relief valve 64. The regulator can be configured to protect against overheating, though the exhaust diverter described below also provides a fail-safe system that does not rely on the regulator to ensure safety from overheating.

Cleaning fluid directed to the fluid applicator (not shown) travels through the supply line 60 and into the first heat exchanger 38, where it circulates to more directly receive heat from the engine coolant in a second preheating stage. The first heat exchanger includes an outer shell or jacket, within which are a plurality of heat exchange tubes. The cleaning water flows through the heat exchange tubes, and the heated engine coolant circulates outside those tubes within the shell or jacket, thereby transferring thermal energy from the coolant to the cleaning water. An engine coolant heat exchanger of this type is disclosed in U.S. Pat. No. 6,675,437. The heat exchange tubes can be smooth tubes, or can be “low fin” tubing, providing additional surface area for heat transfer. One skilled in the art of heat exchange design will be able to select the materials and configure the first heat exchanger to accomplish the desired heat transfer.

Coolant in the engine 28 absorbs excess or waste heat from the engine. The coolant then, optionally, travels through the radiator 52, which cools the coolant by transferring heat to air 66 flowing through the grill into the engine compartment. A thermostatically-controlled or otherwise-controlled coolant control valve 68, can divert the coolant away from the radiator toward the first heat exchanger 38, for heating the cleaning fluid. The coolant control valve can be positioned in a flow of the coolant to control the temperature of the coolant. In such a configuration, the coolant control valve can operate to permit flow exclusively into the first heat exchanger when the coolant is sufficiently cool. Initially, on startup of the system, such will normally be the case.

Once the coolant is heated by the engine 28 to some maximum allowable temperature, or to a temperature sufficiently close to that of the engine, the coolant may not accept enough heat to sufficiently cool the engine simply through the first heat exchanger 38 and coolant return line 54. Consequently, when the first heat exchanger alone is not removing an adequate amount of heat from the coolant, the coolant control valve 68 can direct flow into both the radiator 52 and the first heat exchanger. In one embodiment, an automotive thermostat can serve as the coolant control valve.

A remote sensor (not shown) can also be provided in the storage tank 20 to provide a temperature reading of a fluid at a different location. For example, the remote sensor can be placed in the storage tank to measure the temperature of the cleaning fluid. The remote sensor can then signal the coolant control valve 68 to shunt coolant into the radiator 52 when the temperature of the coolant or of the cleaning fluid in the storage tank reaches a level where cooling of the engine 28 by the first heat exchanger 38 is insufficient. This diverts at least a portion of the coolant back through the radiator 52 for adequate cooling of the engine.

Depending upon the operating temperature of the engine 28 and the temperature of the cleaning water in the storage tank 20, the first heat exchanger 38 can heat the cleaning water to a temperature of from 140° to 170° F.

After heating in the first heat exchanger 38, the cleaning fluid exits the first heat exchanger through conduit 70, and enters the exhaust heat exchanger 26. The cleaning fluid circulates through the exhaust heat exchanger to receive heat in a top-heating stage. Cleaning fluid exiting the exhaust heat exchanger is at a temperature sufficient for carpet cleaning. This second heating stage can raise the temperature of the cleaning fluid to from 170° to 250° F. Then, the cleaning fluid travels through a feed line 72 and into a wand (not shown), where it is directed against a surface to be cleaned (not shown), such as a carpet.

Exhaust 74 from the engine 28 flows through an exhaust pipe 75 and through a muffler 76 before reaching an exhaust diverter valve 78. The exhaust diverter valve allows exhaust gasses to be selectively directed to a first exhaust outlet 80 or to the exhaust heat exchanger 26. The exhaust diverter valve can be pressure-actuated by a vacuum source 82, driven by the engine 28. A bias can be built into the diverter valve, but this can be optional. The default position of the valve allows exhaust to pass directly to the first exhaust outlet, sending none of the exhaust flow through the exhaust heat exchanger. The result is a fail-safe diverter. Any failure of the diverter results in no substantial heat input from the exhaust flow to the cleaning fluid.

The vacuum source 82 may be the engine manifold or a pump (not shown) that is continually coupled to the engine 28 to perform functions necessary for the engine system. When the vacuum pump is connected to the diverter valve 78, low pressure in the pump may be used to actuate the diverter valve to direct exhaust 74 through the exhaust heat exchanger 28 to heat the cleaning fluid.

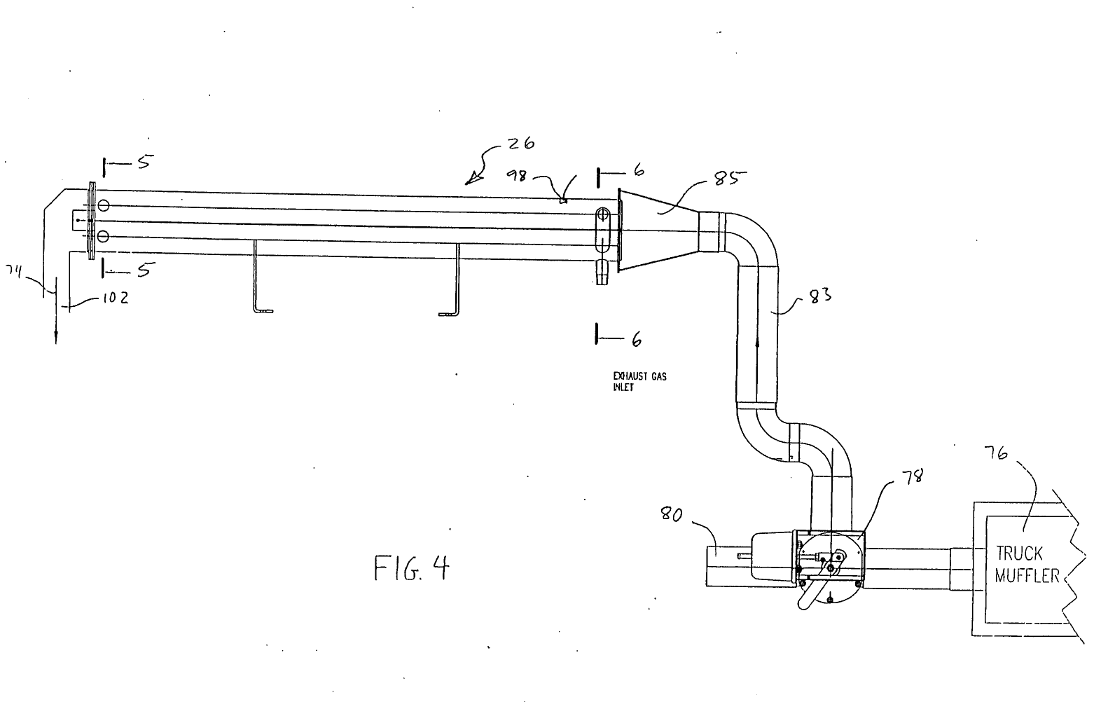

The exhaust heat exchanger 26 is shown in more detail in FIGS. 4-6. An exhaust pipe 83 extends from the diverter valve 78 to the exhaust heat exchanger. A flared or diverging section 85 is provided where this pipe meets the exhaust heat exchanger so as to increase the diameter of the pipe to match the cross-sectional size of the exhaust heat exchanger. The exhaust heat exchanger includes four groups of straight exhaust tubes 84 through which exhaust gasses can pass. To reduce the potential problem of fouling from minerals in the cleaning water, the inventor has used smooth sided tubing for the exhaust tubes. That is, the outer surface of the exhaust tubes (the side contacting the water) is smooth to reduce locations where minerals can build up. The groups of exhaust tubes are each enclosed in a jacket or shell 86, within which the cleaning fluid passes in four stages.

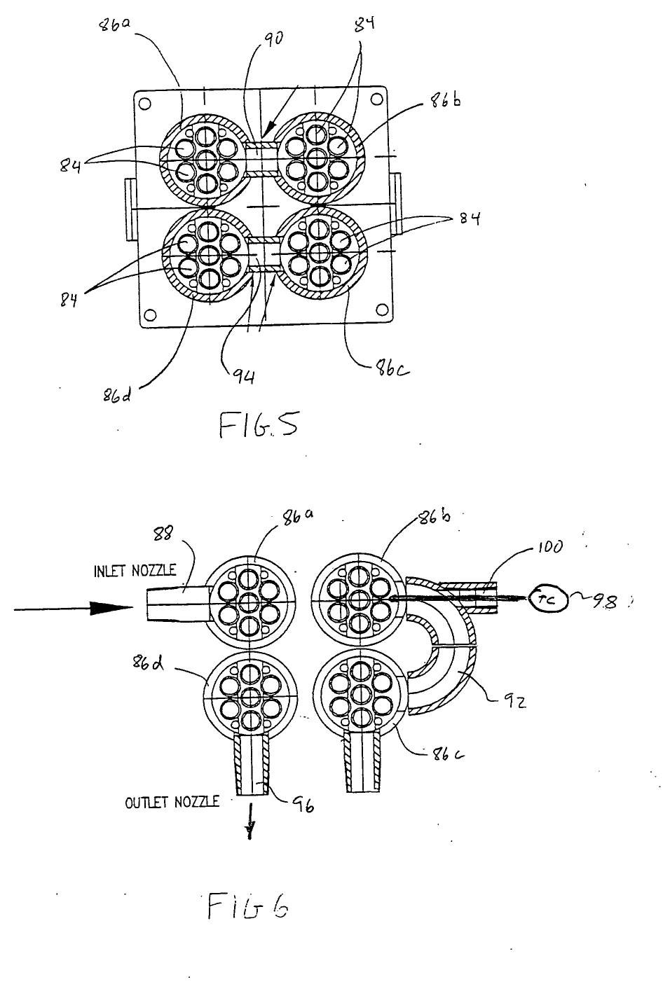

The four stages of the exhaust heat exchanger, labeled 86a, 86b, 86c, and 86d, are sequential. As shown in FIGS. 5 and 6, the water inlet 88 connects into stage 1 (enclosed in jacket 86a). At the end of stage 1, the cleaning water passes through a first transfer conduit 90 and into the far end of stage 2 (jacket 86b). When the water reaches the near end of stage 2, it passes through a second transfer conduit 92 and into the near end of stage 3 (86c). At the far end of stage 3, the water passes through a third transfer conduit 94 and into stage 4 (86d). When the water reaches the near end of stage 4, it then flows through the water outlet 96 and to the end user connections (40 in FIG. 1) for use in cleaning.

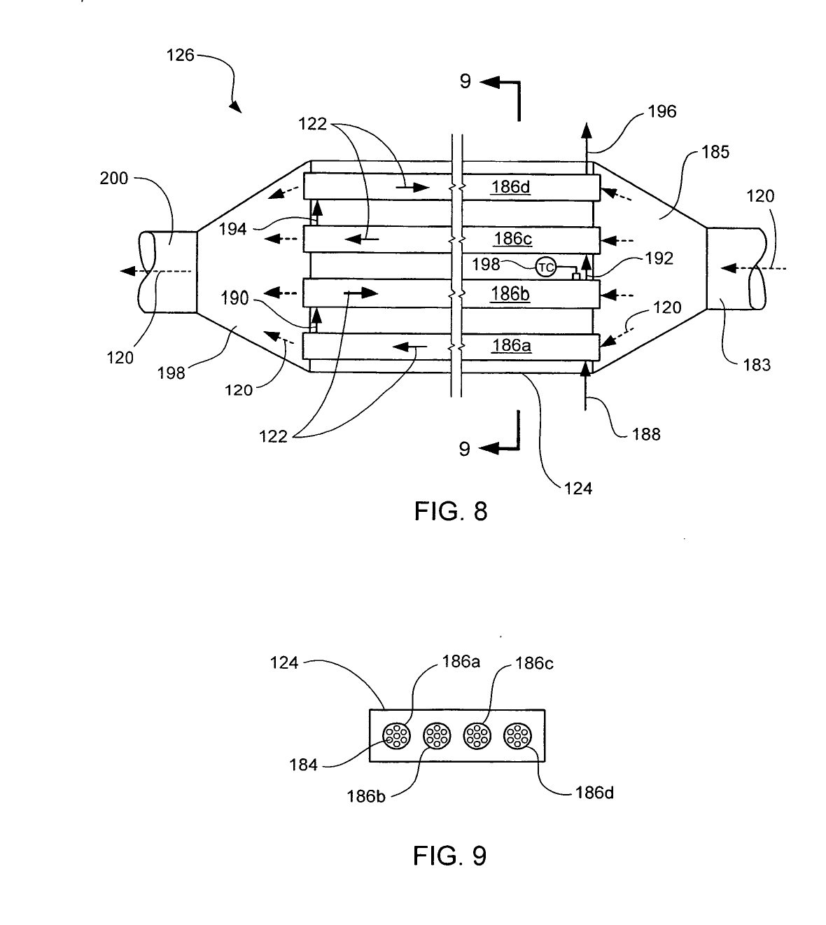

The side-by-side arrangement shown in FIG. 8 has a different geometric configuration than the exhaust heat exchanger 26 shown in FIGS. 5 and 6, but is functionally the same, and provides a good illustration of its operation. In this configuration, the exhaust pipe 183 includes a flared or diverging section 185. The exhaust gasses, represented by dashed arrows 120, flow straight through the four stages of the exhaust heat exchanger. As shown in the cross-sectional view of FIG. 9, each heat exchanger stage includes a group of straight exhaust tubes 184 that are encased in an outer shell or jacket 186. The four stages are designated by the respective outer jackets, labeled 186a-186d. The water inlet, represented by solid arrow 188, connects into stage 1 (186a). The direction of water flow through each stage is shown by solid arrows 122. At the end of stage 1, the cleaning water passes through a first transfer conduit 190 and into the far end of stage 2 (186b). When the water reaches the near end of stage 2, it passes through a second transfer conduit 192 and into the near end of stage 3 (186c). At the far end of stage 3, the water passes through a third transfer conduit 194 and into stage 4 (186d). When the water reaches the near end of stage 4, it then flows through the water outlet 196 for use in cleaning.

This folded or overlapping configuration allows four-stage heat transfer from the exhaust gasses to the cleaning water, while using a minimum of space and minimizing resistance to exhaust flow. It is well know that resistance to outflow of exhaust gasses from an internal combustion engine (backpressure) reduces the performance of the engine. Backpressure is created by catalytic converters, mufflers and other devices that obstruct the exhaust system, and by bends and undulations in the exhaust conduit itself, and friction of the flowing gasses with the sides of the pipe. Friction with the pipe depends in part upon the diameter and length of the pipe—the smaller or longer the pipe, the more frictional resistance is created.

Advantageously, the folded configuration of the exhaust heat exchanger 26 allows it to provide the sequential four stage heating process in one fourth the length that would be required otherwise. This helps reduce backpressure from friction with the exhaust conduit. Additionally, the straight configuration does not introduce resistance to flow that bends or other undulations would provide. The total cross-sectional area of all of the exhaust tubes 84 combined can be less than the cross-sectional area of the exhaust pipe 83. This does not hinder the performance of the mobile washing plant because the truck exhaust system is designed to accommodate exhaust flow when the engine is operating at full load (e.g. when driving), while the exhaust heat exchanger is only used when the truck is parked, and therefore need only be designed to handle exhaust flow when the engine is experiencing a partial load.

Heat transfer is a function of temperature differential, contact area, and time. In the exhaust heat exchanger 26, the contact area is fixed by the geometry of the system and is equal in each stage. The time of contact is a function of the flow rate of the cleaning fluid, which will also be the same for each stage, though it can vary over time as the flow demand varies with the demands of the user. During operation, the temperature of the cleaning fluid in the jacket 86 of each heat transfer stage will increase by some incremental amount. The cleaning water entering stage 2 (86b) will be hotter than that entering stage 1 (86a), and so on. In one embodiment produced by the inventor, it has been found that the cleaning water temperature can increase by about 7° to about 15° F. in each exhaust heating stage. However, since the hot exhaust gas enters all four stages simultaneously, the exhaust gas temperature will be approximately the same at the exhaust inlet end of each stage. Because the cleaning water is increasing in temperature with each stage, the temperature differential between the exhaust gas and the cleaning water may be slightly different in each stage. Consequently, the change in temperature of the cleaning water and of the exhaust gas flowing through each stage may differ, though the difference is not expected to be significant. In general, there is likely to be slightly more heat transfer in stage 1 than in stage 2, and so on.

A temperature sensor (98 in FIG. 2, 198 in FIG. 8) is attached to the water jacket 86 through a fitting 100 at the end of stage 2 (86b). This allows the system to detect the cleaning water temperature at an intermediate point in the four-stage exhaust heat transfer process. If the temperature at this intermediate stage is above a set threshold temperature (e.g. 240° F.), the system disconnects the vacuum pump 82 from the diverter valve 78, allowing a spring in the valve to divert the flow of exhaust 74 to flow directly to the first exhaust outlet 80, without traveling through the exhaust heat exchanger 26. By detecting the temperature at this midway point, the system can avoid temperature spike problems due to on/off water flow. During carpet cleaning, the water flow is not constant, but is repeatedly switched on, then off, then on again. It is relatively easy to control temperature with constant water flow. However, it is much more difficult to control water temperature when the flow is repeatedly switched on, then off at irregular intervals. To provide control for this on/off system and to make the system less complicated, the inventor has used an on/off controller with a deadband of 10° F. This causes the controller not to act until a temperature that is 10° F. above a set point is reached.

With water flowing through the system, the temperature sensor 98 will sense the temperature of the water and transmit a corresponding signal to the temperature controller. The location of the temperature sensor becomes most important when there is no water flow. If the temperature sensor is located away from the exhaust heat exchanger, this will allow temperature spikes when water starts flowing, because the temperature sensor will have been sensing a static temperature away from a location where heat is still being transferred to the water. Locating the temperature sensor between stage 2 and stage 3 of the exhaust heat exchanger allows the controller to be set below the required temperature. When water is not flowing, the exhaust heat exchanger temperature at the temperature sensor location will gradually rise to the set point plus 10° F. (the amount of the deadband), at which point the controller will switch the diverter valve 78 to divert exhaust to flow away from the exhaust heat exchanger.

In the embodiment depicted in FIGS. 1-6, the exhaust heat exchanger 26 is disposed inside the cargo bay 16 of the truck 12. In this configuration, the exhaust pipe 83 from the exhaust diverter valve 78 extends up through the floor (18 in FIG. 3) of the cargo bay of the truck, where it leads to the exhaust heat exchanger. Upon exit from the exhaust heat exchanger, the exhaust gasses 74 are directed downward, back through the floor of the cargo bay, to a second exhaust outlet 102. This configuration, with the exhaust heat exchanger inside the cargo bay of the truck, helps shield the exhaust heat exchanger from outside environmental conditions, such as freezing temperatures.

The exhaust heat exchanger can also be located outside the cargo bay 16. Shown in FIG. 7 is a schematic diagram of an alternative embodiment of a mobile high-temperature washing plant having an exhaust heat exchanger 104 located outside of the cargo bay. In this figure, the floor of the cargo bay is represented by dashed line 106. The exhaust heat exchanger is disposed below the floor of the cargo bay, and conduits 108, 110 extend through the floor to provide water to and retrieve water from the exhaust heat exchanger. Functionally, the embodiment of FIG. 7 works the same as the other embodiments described above.

In FIG. 3 the exhaust heat exchanger 26 is shown oriented parallel to the length of the truck 12. However, the exhaust heat exchanger can be oriented in other ways as well, whether located within or outside of the cargo bay. For example, the inventor has produced trucks in which the exhaust heat exchanger is oriented transverse to the frame of the truck, running side-to-side. Other positions are also possible. Rather than being located just above or below the cargo bay floor, the exhaust heat exchanger could be placed overhead, whether inside or outside the cargo bay. Other positions are also possible.

Additionally, the shape and configuration of the exhaust heat exchanger can take many forms. As depicted in FIGS. 5 and 6, the exhaust heat exchanger 26 can have a stacked or block arrangement, with the separate exhaust tubes of the four stages arranged in a compact square configuration. Alternatively, as shown in FIGS. 8 and 9, an alternatively configured exhaust heat exchanger 126 can have the four stages 186 laid out in a flat side-by-side configuration, and encased in a relatively flat rectangular shell 124. In this configuration, the exhaust pipe 183 includes a flared or diverging section 185 that provides a transition from the circular exhaust pipe shape to the flattened-out rectangular shape of the heat exchanger shell. The exhaust gasses, represented by dashed arrows 120, flow straight through the groups of straight exhaust tubes 184 disposed in each heat exchanger jacket 186, and thence into a converging section 198 which transitions to an exhaust outlet pipe 200. As discussed above, the water inlet 188 connects into stage 1 (186a), and the water flows sequentially through stages 186a to 186d until reaching the water outlet 196. The direction of water flow through each stage is shown by solid arrows 122.

The invention thus provides a mobile washing plant that is capable of safely and efficiently capturing heat from both the radiator coolant and engine exhaust gases of a vehicle. The mobile washing plant can safely provide consistently high cleaning fluid temperatures without overheating, and is rugged, reliable, and has a long useful life. This system is also less complex than other systems that attempt to heat cleaning fluid using exhaust gasses from an internal combustion engine.

By way of example, and without limitation, the invention can be described as a mobile high-temperature washing plant disposed upon a motor vehicle having an engine. The mobile washing plant generally includes a cleaning water storage vessel, a pump configured to pump the cleaning water from the cleaning water storage vessel for cleaning use, and a vacuum system for withdrawing and disposing of used cleaning water. An engine coolant heat exchange system initially heats the cleaning water associated with the water storage vessel to a first elevated temperature, and an exhaust heat exchanger heats the cleaning water to a second higher elevated temperature for cleaning.

As another example, the invention can be described as a vehicle, comprising a frame, an engine affixed to the frame as a prime mover of the vehicle, and a transmission system connected to the engine for transmitting mechanical energy from the engine to the drive train of the vehicle. The engine is configured to be the sole source of energy to pump and heat a cleaning fluid. Also disposed on the vehicle are a storage tank that stores the cleaning fluid, and a pump coupled to the storage tank and configured to pump the cleaning fluid. A power takeoff is connected to the transmission system for driving the liquid pump, and an exhaust line is connected to the engine for conducting combustion exhaust from the engine. An exhaust heat exchanger is connected to the engine to transfer heat from the combustion exhaust directly to the cleaning fluid, so as to heat the cleaning fluid to a temperature suitable for suspending particulate matter from a carpet.

As another example, the invention can be described as a transportable cleaning apparatus for heating and pressurizing a cleaning fluid for cleaning purposes. The apparatus includes an engine configured to provide a motive force for the apparatus and to pump and heat the cleaning fluid to a suitable temperature for a desired cleaning purpose, and a transmission system coupled to the engine. The apparatus includes a storage tank that stores the cleaning fluid. A fluid pump is in fluid communication with the cleaning fluid in the storage tank and is configured to pump the cleaning fluid through a cleaning fluid conduit. A first heat exchanger is disposed along the cleaning fluid conduit and coupled to the engine, and configured to receive a thermal transfer fluid from the engine and to heat the cleaning fluid as the cleaning fluid conduit passes through the first heat exchanger in a first heating stage. A second exhaust heat exchanger is disposed along the cleaning fluid conduit and coupled to an exhaust conduit of the engine, and configured to receive hot exhaust gasses from the engine and to heat the cleaning fluid as the cleaning fluid conduit passes through the exhaust heat exchanger in a second heating stage.

As yet another example, the invention can be described as a four-stage exhaust heat exchanger. The four-stage exhaust heat exchanger includes an exhaust pipe configured to direct hot exhaust gasses from an engine, and a plurality of groups of exhaust conduits arranged in parallel, in fluid communication with the exhaust pipe. An elongate fluid jacket is disposed around each of the plurality of groups of exhaust conduits, and is configured to allow cleaning fluid to circulate around the exhaust conduits, the exhaust conduits separating the cleaning fluid from the exhaust gasses. Transfer conduits are placed to interconnect the fluid jackets in series, such that cleaning fluid introduced into a first of the fluid jackets will flow sequentially through each fluid jacket to an outlet disposed in a last of the fluid jackets, such that the cleaning fluid is heated by thermal transfer from the hot exhaust gasses in successive stages.

It is to be understood that the above-referenced arrangements are only illustrative of the application of the principles of the present invention in one or more particular applications. Numerous modifications and alternative arrangements in form, usage and details of implementation can be devised without the exercise of inventive faculty, and without departing from the principles, concepts, and scope of the invention as disclosed herein. Accordingly, it is not intended that the invention be limited, except as set forth in the claims.

What is claimed is:

1. A mobile high-temperature washing plant disposed upon a motor vehicle having an engine, comprising:
a cleaning water storage vessel containing cleaning water;
an engine coolant heat exchange system, configured to transfer heat from coolant associated with the engine to the cleaning water, so as to heat the cleaning water to a first elevated temperature;
an exhaust heat exchanger, configured to heat the cleaning water to a second higher elevated temperature for cleaning;
a pump configured to pump the cleaning water from the cleaning water storage vessel for cleaning use; and
a vacuum system for withdrawing and disposing of used cleaning water.

2. A mobile high-temperature washing plant in accordance with claim 1, wherein the first elevated temperature is at least about 140° F., and the second elevated temperature is at least about 170° F.

3. A mobile high-temperature washing plant in accordance with claim 1, wherein the first elevated temperature is in the range of from about 140° to about 170° F., and the second elevated temperature is in the range of from about 170° to about 250° F.

4. A mobile high-temperature washing plant in accordance with claim 1, further comprising a controller, configured to regulate a flow of engine coolant to the engine coolant heat exchange system in response to temperature levels of cleaning water in the engine coolant heat exchange system and of engine coolant in the engine.

5. A mobile high-temperature washing plant in accordance with claim 1, further comprising an exhaust diverter valve, configured to selectively direct exhaust gases toward or away from the exhaust heat exchanger.

6. A mobile high-temperature washing plant in accordance with claim 5, wherein the exhaust diverter valve is biased to direct exhaust gases away from the exhaust heat exchanger.

7. A mobile high-temperature washing plant in accordance with claim 1, wherein the exhaust heat exchanger is disposed within a cargo bay of the vehicle.

8. A mobile high-temperature washing plant in accordance with claim 1, wherein the exhaust heat exchanger comprises:
a plurality of groups of exhaust conduits, in fluid communication with an exhaust pipe of the vehicle;
an elongate fluid jacket, disposed around each of the plurality of groups of exhaust conduits, configured to allow cleaning water to circulate around the exhaust conduits, the exhaust conduits separating the cleaning water from the exhaust gasses, each group of exhaust conduits and the associated fluid jacket comprising a heating stage; and
a plurality of transfer conduits, placed to interconnect the fluid jackets in series, such that cleaning water introduced into a first of the fluid jackets will flow sequentially through each fluid jacket to an outlet disposed in a last of the fluid jackets, such that the cleaning water is heated by thermal transfer from the hot exhaust gasses in successive heating stages.

9. A mobile high-temperature washing plant in accordance with claim 8, wherein the exhaust heat exchanger comprises first, second, third and fourth stages, arranged in parallel with respect to the flow of exhaust gas in the exhaust pipe.

10. A mobile high-temperature washing plant in accordance with claim 9, further comprising a temperature sensor disposed in a transfer conduit between the second and third heating stages, configured to detect a temperature of cleaning water in the transfer conduit, and to activate an exhaust diverter valve, configured to direct exhaust gases away from the exhaust heat exchanger, if the temperature of the cleaning water in the transfer conduit exceeds a temperature setting.

11. A transportable cleaning apparatus for heating and pressurizing a cleaning fluid for cleaning purposes, comprising:
an engine configured to provide a motive force for the apparatus and to pump and heat the cleaning fluid to an elevated temperature for cleaning;
a transmission system coupled to the engine;
a storage tank that stores the cleaning fluid;
fluid pump, in fluid communication with the cleaning fluid in the storage tank and configured to pump the cleaning fluid through a cleaning fluid conduit;
a first heat exchanger, disposed along the cleaning fluid conduit and coupled to the engine, and configured to receive a thermal transfer fluid from the engine and to heat the cleaning fluid as the cleaning fluid conduit passes through the first heat exchanger in a first heating stage.
a second heat exchanger, disposed along the cleaning fluid conduit and coupled to an exhaust conduit of the engine, configured to receive hot exhaust gasses from the engine and to heat the cleaning fluid as the cleaning fluid conduit passes through the exhaust heat exchanger in a second heating stage.

12. A transportable cleaning apparatus in accordance with claim 11, wherein the first heating stage is configured to raise the temperature of the cleaning fluid to at least about 140° F., and the second heating stage is configured to raise the temperature of the cleaning fluid to at least about 170° F.

13. A transportable cleaning apparatus in accordance with claim 11, further comprising an exhaust diverter valve, configured to selectively direct exhaust gases toward or away from the second heat exchanger.

14. A transportable cleaning apparatus in accordance with claim 11, wherein the second heat exchanger comprises:
a plurality of groups of exhaust conduits, in fluid communication with an exhaust pipe of the vehicle;
an elongate fluid jacket, disposed around each of the plurality of groups of exhaust conduits, configured to allow cleaning water to circulate around the exhaust conduits, the exhaust conduits separating the cleaning water from the exhaust gasses, each group of exhaust conduits and the associated fluid jacket comprising an exhaust heating stage; and
a plurality of transfer conduits, placed to interconnect the fluid jackets in series, such that cleaning water introduced into a first of the fluid jackets will flow sequentially through each fluid jacket to an outlet disposed in a last of the fluid jackets, such that the cleaning water is heated by thermal transfer from the hot exhaust gasses in the successive exhaust heating stages.

15. A transportable cleaning apparatus in accordance with claim 12, wherein the second heat exchanger comprises first, second, third and fourth exhaust heating stages, arranged in parallel with respect to the flow of exhaust gas in the exhaust pipe.

16. A multiple-stage exhaust heat exchanger, comprising:
an exhaust pipe configured to direct hot exhaust gasses from an engine;
a plurality of groups of exhaust conduits, in fluid communication with the exhaust pipe;
an elongate fluid jacket, disposed around each of the plurality of groups of exhaust conduits, configured to allow cleaning fluid to circulate around the exhaust conduits, the exhaust conduits separating the cleaning fluid from the exhaust gasses; and
a plurality of transfer conduits, placed to interconnect the fluid jackets in series, such that cleaning fluid introduced into a first of the fluid jackets will flow sequentially through each fluid jacket to an outlet disposed in a last of the fluid jackets, such that the cleaning fluid is heated by thermal transfer from the hot exhaust gasses in successive exhaust heating stages.

17. An exhaust heat exchanger in accordance with claim 16, wherein the exhaust heat exchanger comprises first, second, third and fourth exhaust heating stages, arranged in parallel with respect to the flow of exhaust gas in the exhaust pipe.

18. An exhaust heat exchanger in accordance with claim 17, further comprising a temperature sensor disposed in a transfer conduit between the second and third heating stages, configured to detect a temperature of cleaning water in the transfer conduit, and to activate an exhaust diverter valve, configured to direct exhaust gases away from the exhaust heat exchanger, if the temperature of the cleaning water in the transfer conduit exceeds a temperature setting.

19. An exhaust heat exchanger in accordance with claim 16, wherein the exhaust heat exchanger is located within a cargo bay of a vehicle that is powered by the engine.

20. An exhaust heat exchanger in accordance with claim 16, wherein the exhaust heat exchanger is configured to heat the cleaning fluid to a temperature of at least about 170° F.
